(19) United States
(12) Patent Application Publication
(10) Pub. No.: US 2019/0009866 A1
(43) Pub. Date: Jan. 10, 2019

(54) GIMBAL SYSTEM

(71) Applicant: LORD Corporation, Cary, NC (US)

(72) Inventor: Peter JONES, Erie, PA (US)

(73) Assignee: LORD Corporation, Cary, NC (US)

(21) Appl. No.: 15/752,439

(22) PCT Filed: Sep. 1, 2016
(86) PCT No.: PCT/US2016/049929

§ 371 Date: Feb. 13, 2018

Related U.S. Application Data
(60) Provisional application No. 62/214,502, filed on Sep. 4, 2015.

(51) Int. Cl. B63B 27/36; F16C 17/02

(52) U.S. Cl. CPC B63B 27/36; B63B 2017/0072; F16C 17/02

(57) ABSTRACT

A gimbal (200) has an intermediate plate (202), a first plate (204) offset from the intermediate plate (202) in a first direction, a first bearing (208) having a first rotational axis connected between the intermediate plate (202) and the first plate (204), a second plate (206) offset from the intermediate plate (202) in a second direction opposite the first direction, and a second bearing (210) having a second rotational axis connected between the intermediate plate (202) and the second plate (206).

### CROSS-REFERENCE TO RELATED APPLICATIONS

The present application claims priority to U.S. Provisional Patent Application Ser. No. 62/214,502, filed on Sep. 4, 2015, entitled “GIMBAL SYSTEM,” the disclosure of which is incorporated herein by reference in its entirety.

### FIELD OF THE INVENTION

Embodiments described herein relate to systems and methods of providing flexible supports in ship-based equipment maintenance systems.

### BACKGROUND

Some supports for ship-based equipment maintenance systems comprise bearings configured to allow relative cocking motions between ship-based platforms and equipment being maintained and/or otherwise being prepared for deployment subsea.

### SUMMARY

In one aspect, a gimbal is provided. The gimbal comprises an intermediate plate, a first plate, a first bearing, a second plate and a second bearing. The first plate is offset from the intermediate plate in a first direction. The first bearing includes a first rotational axis connected between the intermediate plate and the first plate. The second plate is offset from the intermediate plate in a second direction opposite the first direction. The second bearing includes a second rotational axis connected between the intermediate plate and the second plate.

### BRIEF DESCRIPTION OF THE DRAWINGS

FIG. 1 is an oblique view of a ship-based equipment maintenance systems according to this disclosure.

FIG. 2 is an oblique partially exploded partial view of the ship-based equipment maintenance systems of FIG. 1.

FIG. 3 is a simplified schematic view of a gimbal of FIG. 2 shown in relation to other components of the system of FIG. 1.

FIG. 4 is an oblique view of the gimbal of FIG. 2.

FIG. 5 is an oblique view of an intermediate plate and bearings of the gimbal of FIG. 2.

FIG. 6 is an orthogonal side view, 45 degrees angularly offset from a direction of a notch of the gimbal of FIG. 2, with all three of the plates of the gimbal disposed parallel to each other.

FIG. 7 is an orthogonal side view, 45 degrees angularly offset in a first direction from a direction of the opening of a notch of the gimbal of FIG. 2, with the intermediate plate at an angle relative to the first plate and the intermediate plate parallel to the second plate.

FIG. 8 is an orthogonal side view, 45 degrees angularly offset in a second direction (opposite the first direction described above with regard to FIGS. 6 and 7) from a direction of the opening of a notch of the gimbal of FIG. 2, with the intermediate plate parallel to the first plate and the intermediate plate at an angle to the second plate.

FIG. 9 is an oblique view of a bearing having a first configuration.

FIG. 10 is an oblique view of a bearing having a second configuration.

FIG. 11 is an oblique view of a block of the bearing of FIG. 9.

FIG. 12 is an oblique view of a bearing insert of the bearing of FIG. 9.

FIG. 13 is an oblique section view of the bearing inner member of FIG. 9.

FIG. 14 is an oblique view of a straight connector of the bearing of FIG. 9.

FIG. 15 is an oblique view of an angled connector of the bearing of FIG. 9.

FIG. 16 is an oblique view of another embodiment of a gimbal suitable for use in the system of FIG. 1.

FIG. 17 is an orthogonal side view of the gimbal of FIG. 16.

FIG. 18 is an orthogonal top cross-sectional view of the gimbal of FIG. 16 taken along cutting line B-B of FIG. 17.

FIG. 19 is an orthogonal side cross-sectional view of the gimbal of FIG. 16 taken along cutting line C-C of FIG. 18.

FIG. 20 is an orthogonal side cross-sectional view of a bearing according to an alternative embodiment.

### DETAILED DESCRIPTION

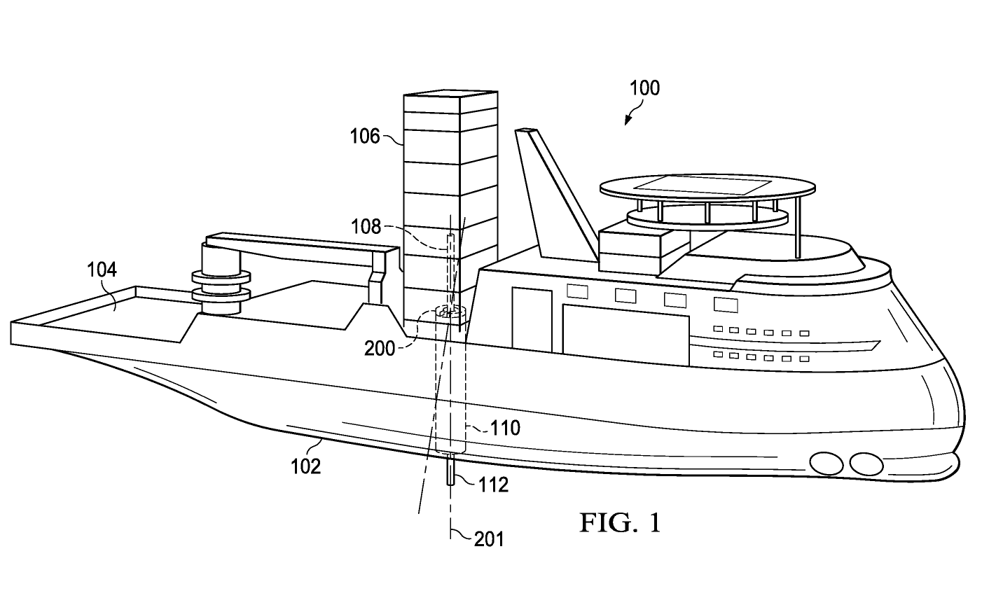

Referring to FIG. 1, a ship-based equipment maintenance systems 100 is shown. The system 100 comprises a ship 102 comprising a deck 104, a module handling tower (MHT) 106 that extends vertically above the deck 104. The MHT 106 can be configured to support and/or manipulate, among other equipment, a modular boosting unit (MBU) 108 that comprises electric submersible pumps to pump crude oil from artificial lift manifolds. The ship 102 further comprises a moonpool 110 that allows access to seawater through the deck 104 and hull of the ship 102. In some cases, equipment, such as, but not limited to, the MBU 108 can be delivered and retrieved from the seawater via the moonpool 110. In some cases, an MBU 108 can be attached to a caisson 112 that extends below the MBU 108 while the MBU 108 is supported by the ship 102. In some cases, because the ship 102 is not highly restrained relative to the seafloor, waves and/or other seawater action can cause movement of the ship 102 and the equipment onboard the ship 102 to move out of alignment with the generally vertical axis alignment shown in FIG. 1. While the MBU 108 and/or other equipment is carried by the ship 102, it can be desirable for the MBU 108 to be allowed to move relative to the remainder of the ship 102 while remaining vertically supported by the ship 102 so that despite waves and/or other seawater action acting on the caisson 112 or other components that extend into the seawater via the moonpool 110 do not cause damage to the vertically supported equipment. Accordingly, the system 100 comprises a gimbal 200 that can vertically support the MBU 108 while also allowing relative cocking displacement between the supported equipment and other portions of the ship. In some cases, the equipment vertically supported by the gimbal 200 can be tethered to other equipment on the seafloor.

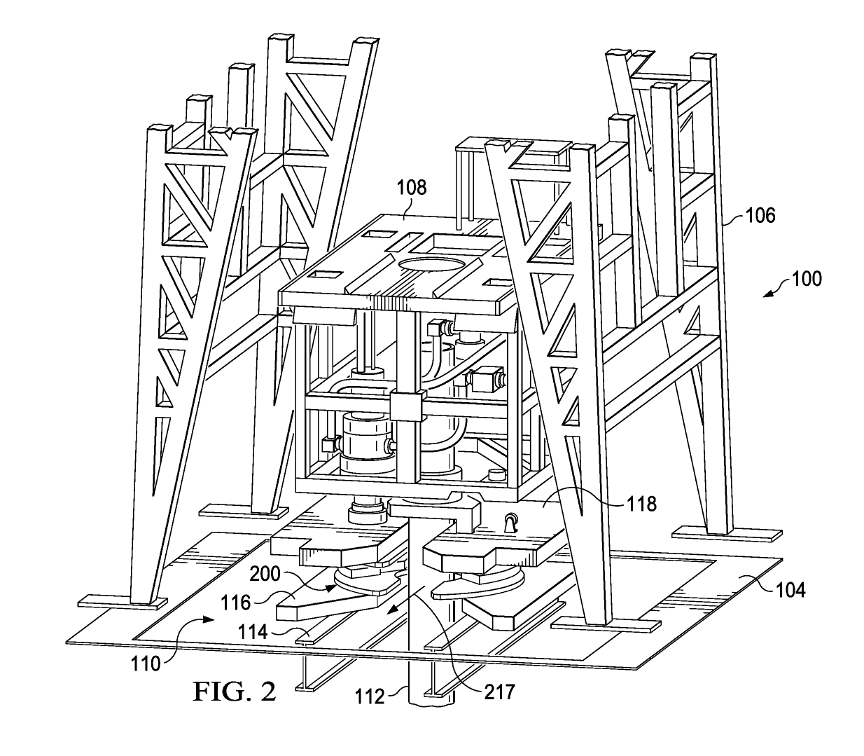

Referring now to FIG. 2, oblique partially exploded partial view of the system 100 is shown. More specifically, FIG. 2 shows the gimbal 200 in location relative to other ship 102 components. In this embodiment, the deck 104 vertically supports crossbeams 114 above the moonpool 110. The crossbeams 114 vertically support a launch bridge 116 that includes a v-notch for receiving equipment into a central channel of the launch bridge 116. The gimbal 200, shown in a simplified schematic manner in FIG. 2, is disposed atop the launch bridge 116 and an elevation platform 118 is disposed atop the gimbal 200. Further, the MBU 108 is disposed atop the elevation platform 118. Accordingly, as a function of the provision of the gimbal 200, a first group of components comprising the launch bridge 116, the crossbeams 114, and the deck 104 are allowed to move relative to a second group of components comprising the elevation platform 118 and the MBU 108. As such, the MBU 108 can be vertically supported above the moonpool 110 and allowed to move relative to the ship 102 so that the MBU 108 and components attached to the MBU 108 are exposed to lower bending forces as a result of waves, other seawater action, and/or movement of the ship 102.

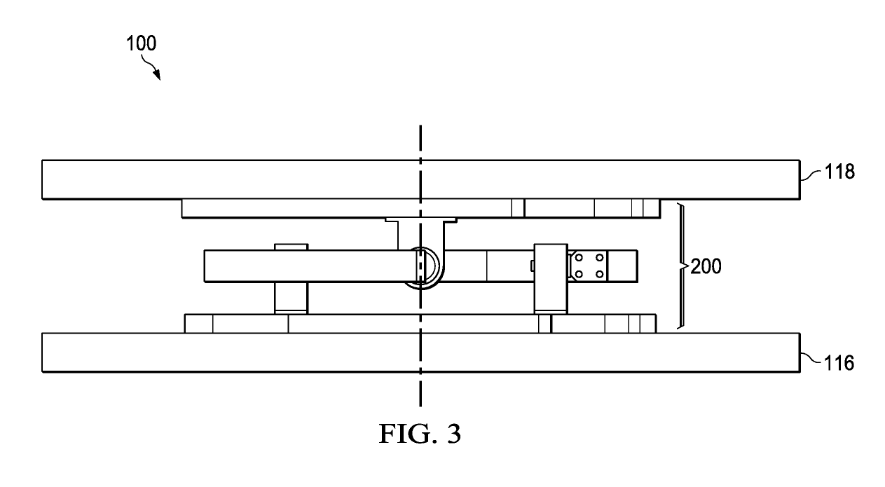

Referring now to FIG. 3, another simplified schematic view of the system 100 is shown. FIG. 3 is an orthogonal side view of the gimbal 200 in location relative to the elevation platform 118 and the launch bridge 116. FIG. 3 shows the elevation platform 118 and the launch bridge 116 in substantially parallel positions relative to each other. In some embodiments, when the elevation platform 118 and the launch bridge 116 are substantially parallel to each other, the gimbal is primarily configured to provide vertical support of an MBU 108 and/or other components belonging to a group similar to the first group of components described above. As shown in FIG. 3, the gimbal 200 comprises a plurality of components.

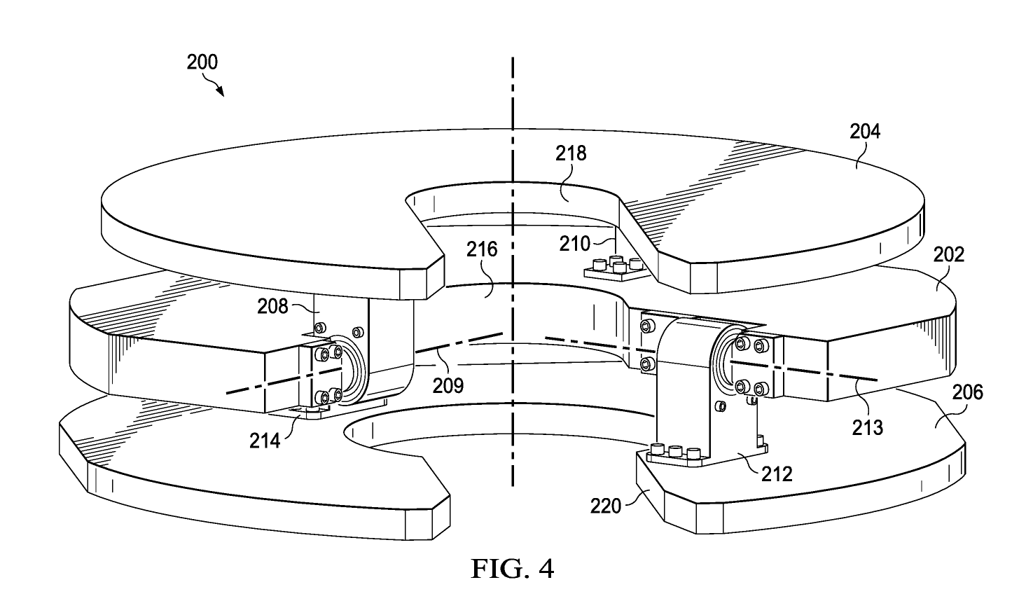

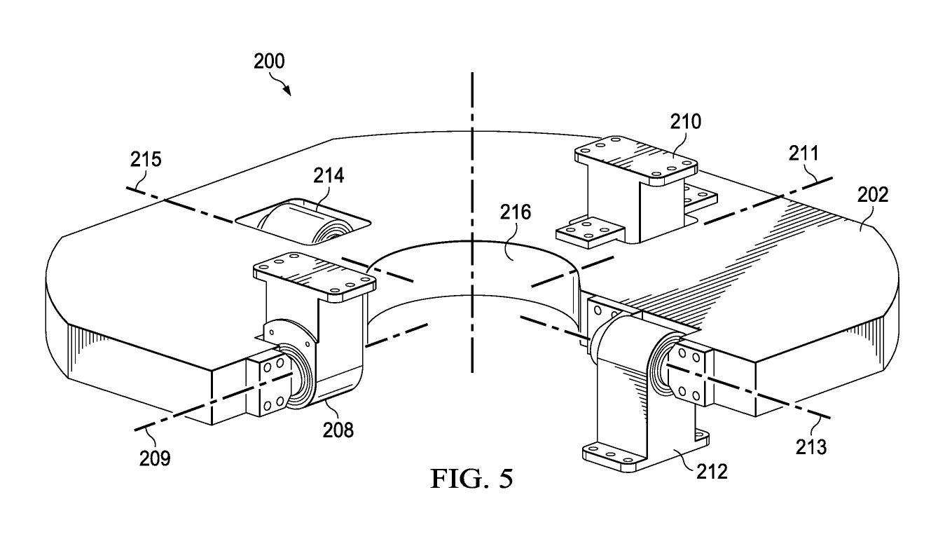

Referring now to FIG. 4, an oblique view of the gimbal 200 is shown. The gimbal 200 generally comprises three plates and a plurality bearings. The three plates are disposed relative to each other in an offset manner and are restrained relative to each other by the plurality of bearings. The gimbal 200 comprises an intermediate plate 202 disposed between a first plate 204 and a second plate 206. The first plate 204 is connected to the intermediate plate 202 by a first bearing 208 and a second bearing 210. The first bearing 208 comprises a first rotational axis 209 and the second bearing 210 comprises a second rotational axis 211. The second plate 206 is connected to the intermediate plate 202 by a third bearing 212 and a fourth bearing 214. The third bearing 212 comprises a third rotational axis 213 and the fourth bearing comprises a fourth rotational axis 215. The intermediate plate 202, the first plate 204, and the second plate 206 comprise notches 216, 218, 220, respectively, for receiving equipment into a relatively central vertical channel in the gimbal 200. The notches 216, 218, 220 are angularly aligned with each other so that each comprises a concavity open in a substantially similar radial direction 217 as shown in FIG. 2. With the gimbal 200 oriented as shown in FIG. 4, each of the first rotational axis 209, second rotational axis 211, third rotational axis 213, and fourth rotational axis are substantially coplanar.

In this embodiment, the gimbal 200 is configured so that the first bearing 208 and the second bearing 210 comprise concentric axes of rotation that, when viewed from above, are angularly offset from the radial direction of the openings of the notches 216, 218, 220. Further, in this embodiment, the gimbal 200 is configured so that the third bearing 212 and the fourth bearing 214 comprise concentric axes of rotation that, when viewed from above, are orthogonal relative to the axes of the first bearing 208 and the second bearing 210.

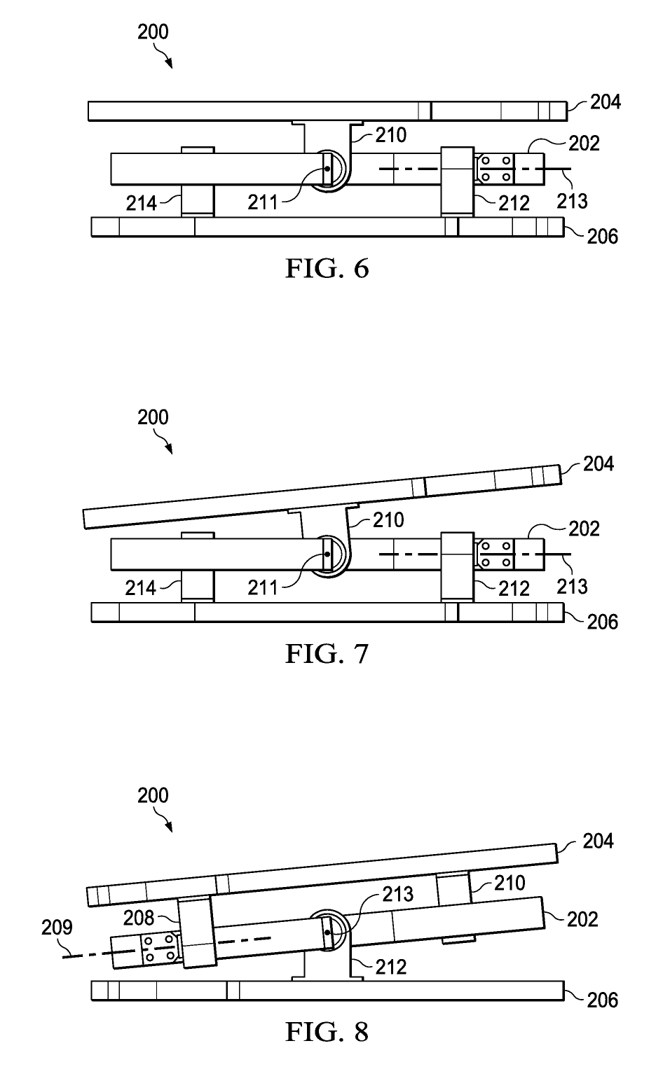

Referring now to FIG. 6, a side view of the gimbal 200 is shown with the first plate 204 and second plate 206 both oriented substantially parallel relative to the intermediate plate 202.

Referring now to FIG. 7, a side view of the gimbal 200 is shown with the first plate 204 rotated about the axes of the first bearing 208 and the second bearing 210 so that the first plate 204 is not parallel relative to the intermediate plate 202. FIG. 7 further shows that the second plate 206 is oriented substantially parallel relative to the intermediate plate 202 even while the first plate 204 is not parallel relative to the intermediate plate 202.

Referring now to FIG. 8, a side view of the gimbal 200 is shown with the first plate 204 parallel relative to the intermediate plate 202 and with the second plate 206 not being parallel relative to the intermediate plate 202. The second plate 206 is moved relative to the intermediate plate 202 through rotation about the third rotational axis 213 of the third bearing 212 and the fourth rotational axis 215 of the fourth bearing 214.

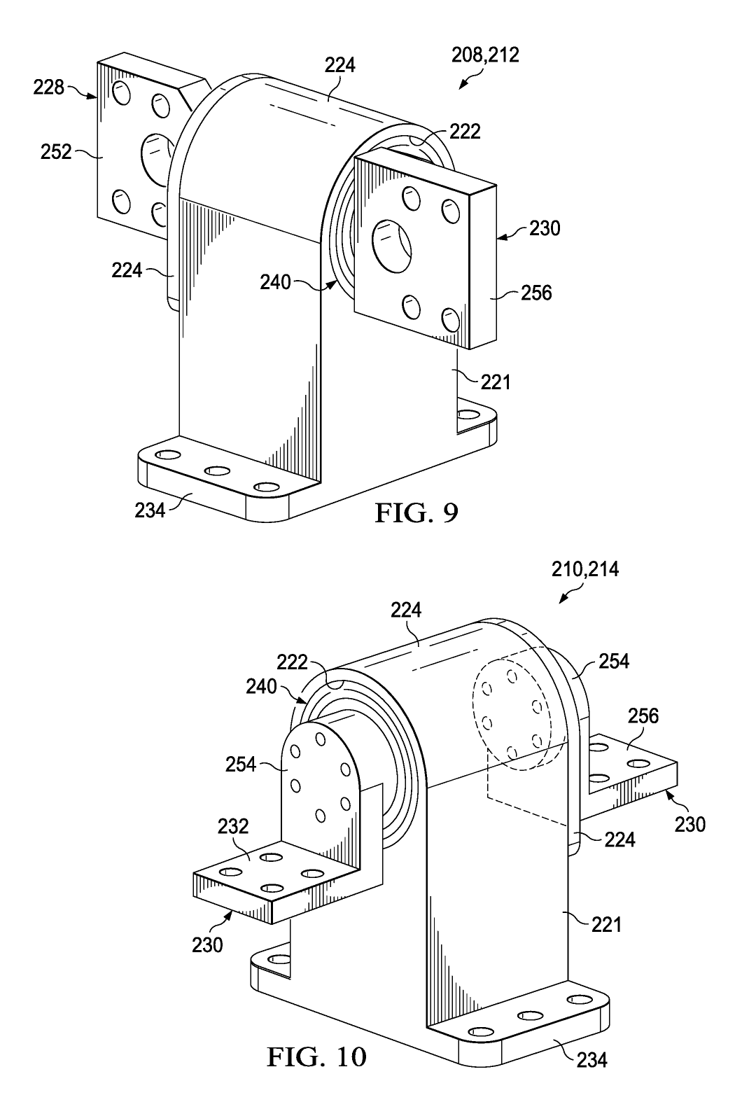

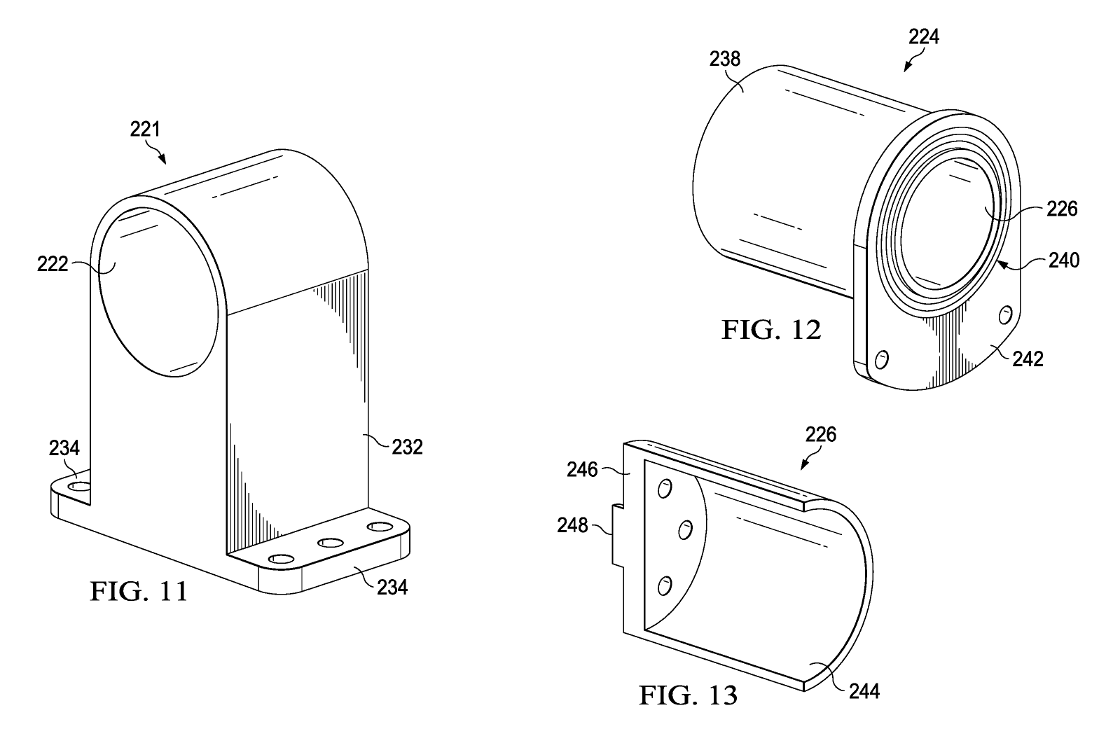

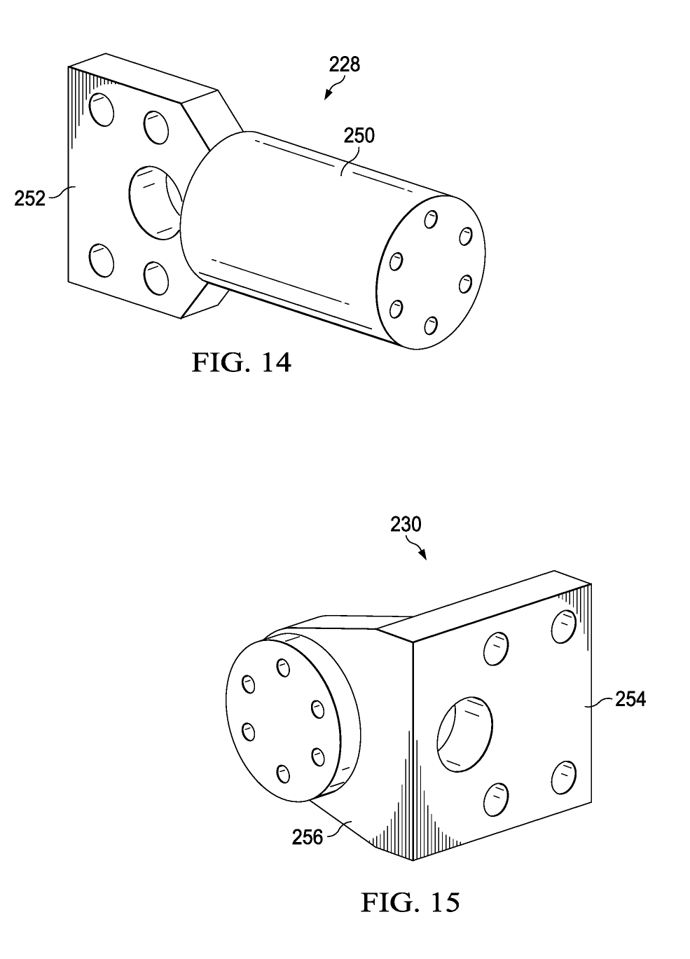

Referring now to FIG. 9 a representative bearing is shown as configured substantially similar to first bearing 208 and third bearing 212. First bearings 208 and third bearings 212 generally comprise a block 221 (see FIG. 11) comprising a central bore 222 configured to receive a bearing insert 224 (see FIG. 12) comprising an inner member 226 (see FIG. 13), a straight connector 228 (see FIG. 14) configured for insertion into the inner member 226, and a first angled connector 230 (see FIG. 15) configured for connection to the inner member 226.

Referring now to FIG. 10 a representative bearing is shown as configured substantially similar to second bearing 210 and fourth bearing 214. Second bearings 210 and fourth bearings 214 generally comprise a block 221 (see FIG. 11) comprising a central bore 222 configured to receive a bearing insert 224 (see FIG. 12) comprising an inner member 226 (see FIG. 13), a first angled connector 230 (see FIG. 15) configured for connection to the inner member 226, and a second angled connector substantially similar to the first angled connector 230 but further comprising a cylindrical protrusion configured for insertion into the inner member 226.

Referring now to FIG. 11, the block 221 generally comprises a body 232 comprising the central bore 222. Mounting legs 234 are connected to the block 221 and comprise holes for receiving fasteners. The block 221 can be mounted to intermediate plate 202, first plate 204, and second plate 206 using the mounting legs 234.

Referring now to FIG. 12, the bearing insert comprising bearing insert 224 comprises the inner member 226 that is generally tubular, a tubular outer portion 238, and bearing elements 240. The bearing elements 240 are configured to allow rotational movement of the inner member 226 relative to the tubular outer portion 238. In some embodiments, the bearing elements 240 can comprise a series of tubular elastomeric inserts separated by substantially rigid tubular elements. In this embodiment, the tubular outer portion 238 further comprises a tab 242 comprising holes configured to receive fasteners. The tab 242 can be used to secure the tubular outer portion 238 to the block 221 and prevent rotation of the tubular outer portion 238 relative to the central bore 222 of the block 221. In some embodiments, the bearing insert 224 is configured to allow about 360 degrees of rotation of the inner member 226 relative to the tubular outer portion 238.

Referring now to FIG. 13, the inner member 226 comprises a tubular body 244 and the tubular body 244 is open on one end and substantially closed by a cap 246 on the other end. The cap 246 comprises holes for receiving fasteners. The cap 246 further comprises a pilot diameter 248 extending away from the tubular body 244.

Referring now to FIG. 14, the straight connector 228 comprises a cylindrical body 250 comprising holes for receiving fasteners on one end and a mount plate 252 extending from the other end. The mount plate 252 comprises holes for receiving fasteners.

Referring now to FIG. 15, the first angled connector 230 comprises a plate-like bearing mount 254 connected substantially orthogonally to a plate-like plate mount 256. The bearing mount 254 comprises holes for receiving fasteners and is configured for interfacing a remainder of the bearing. The plate mount 256 comprises holes for receiving fasteners and is configured for interfacing a plate, such as intermediate plate 202, first plate 204, and second plate 206.

In some embodiments, the center of rotation of the gimbal 200 is located along a vertical centerline of the gimbal 200. In some embodiments, the gimbal 200 can comprise a misalignment nominal stiffness of 3,850 ft-lbs/deg. In some embodiments, the radial stiffness related to axial motion on the radial journal bearings of the gimbal 200 can be about 126,000 lbs/in. In some embodiments, the gimbal can allow up to about 20 degrees of cocking or axial misalignment relative to a central vertical axis 201 of the gimbal 200.

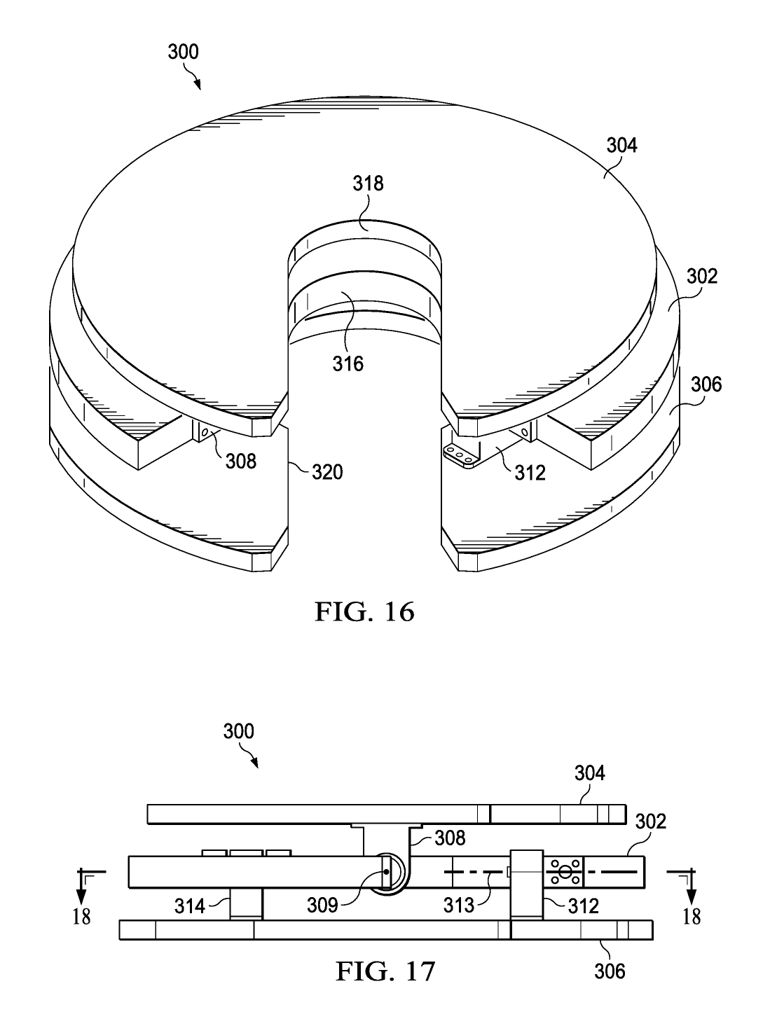

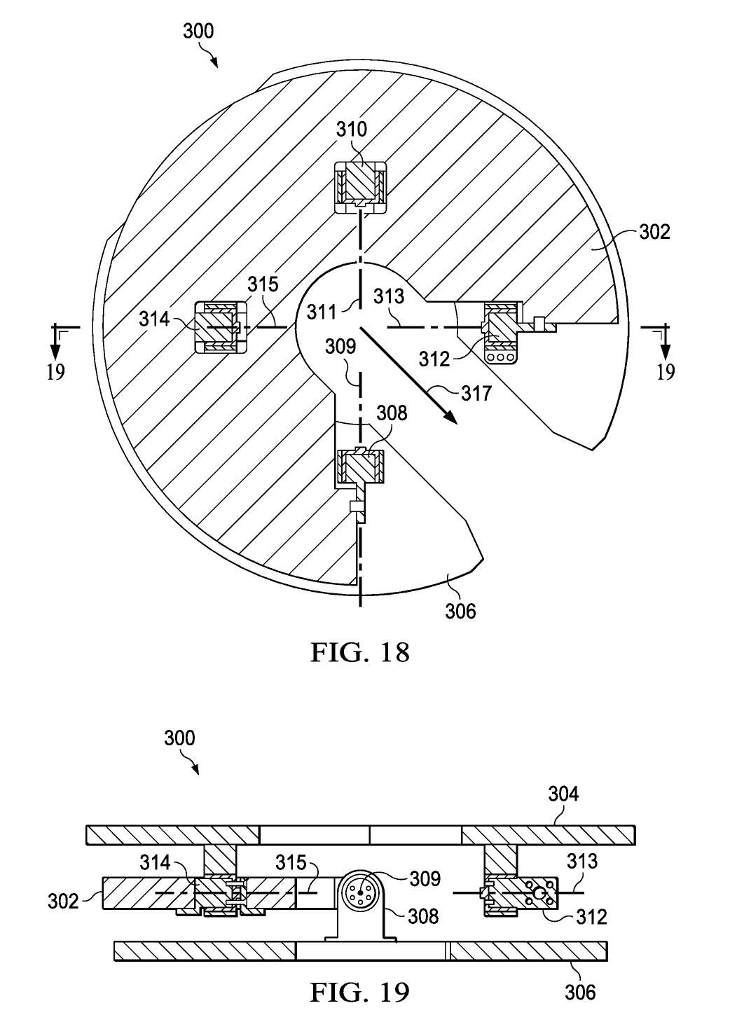

Referring now to FIGS. 16 and 17, oblique and side views of a gimbal 300 are shown, respectively. The gimbal 300 generally comprises three plates and a plurality bearings. The three plates are disposed relative to each other in an offset manner and are restrained relative to each other by the plurality of bearings. The gimbal 300 comprises an intermediate plate 302 disposed between a first plate 304 and a second plate 306. The first plate 304 is connected to the intermediate plate 302 by a first bearing 308 and a second bearing 310. The second plate 306 is connected to the intermediate plate 302 by a third bearing 312 and a fourth bearing 314. The intermediate plate 302, the first plate 304, and the second plate 306 comprise notches 316, 318, 320, respectively, for receiving equipment into a relatively central vertical channel in the gimbal 300. The notches 316, 318, 320 are angularly aligned with each other so that each comprises a concavity open in a substantially similar radial direction 317 as shown in FIG. 18.

In this embodiment, the gimbal 300 is configured so that the first bearing 308 and the second bearing 310 comprise concentric rotational axes 309, 311, respectively, that when viewed from above, are angularly offset from the radial direction 317 of the openings of the notches 316, 318, 320 by 45 degrees. Further, in this embodiment, the gimbal 300 is configured so that the third bearing 312 and the fourth bearing 314 comprise concentric rotational axes 313, 315, respectively, that when viewed from above, are orthogonal relative to the axes of the first bearing 308 and the second bearing 310.

Referring now to FIG. 18, an orthogonal top cross-sectional view of gimbal 300 taken along cutting line B-B of FIG. 17 is shown. This view shows the location of each of the first bearing 308, second bearing 310, third bearing 312, and fourth bearing 314.

Referring now to FIG. 19, an orthogonal side cross-sectional view of gimbal 300 taken along cutting line C-C of FIG. 18 is shown with the addition of showing the first plate 304. FIG. 19 shows gimbal 300 with the first plate 304 and second plate 306 both oriented substantially parallel relative to the intermediate plate 302.

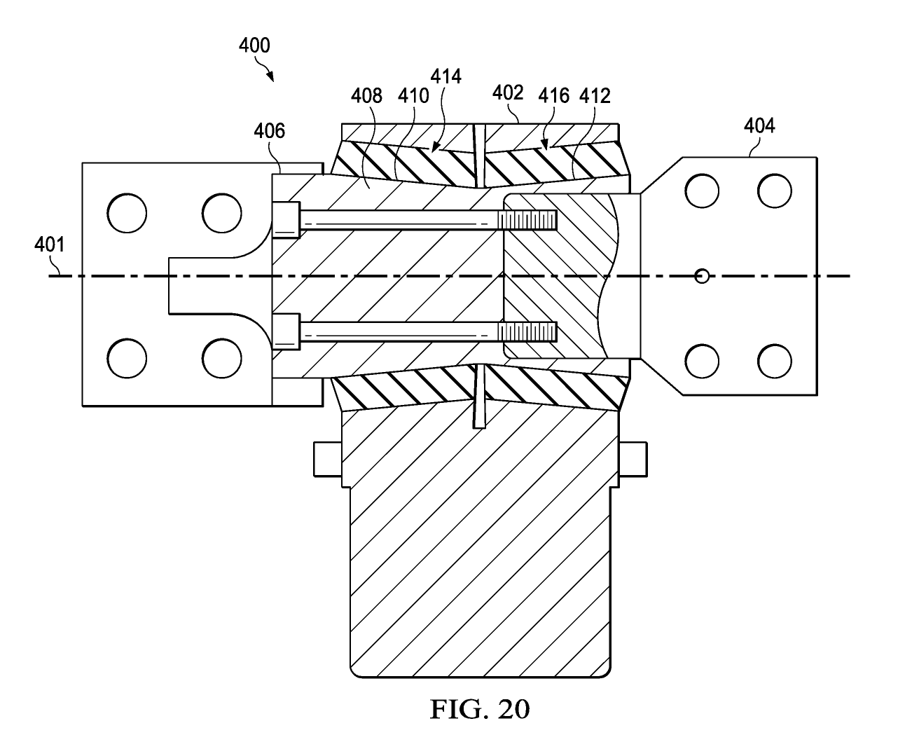

Referring now to FIG. 20, an orthogonal side cross-sectional view of a bearing 400 is shown. Most generally, while the bearings 308, 310, 312, 314 are disclosed and described above as comprising substantially tubular shapes, bearing 400 is configured to include conical angles that increase stiffness along the rotational axis 401 of the bearing 400. The bearing 400 comprises a block 402 substantially similar to block 221, a straight connector 404 that is substantially similar to straight connector 228, and an angled connector 406 substantially similar to first angled connector 230. However, the straight connector 404 comprises a an angled body 408 rather than a cylindrical body. The angled body 408 generally comprises a first neck portion 410 that is more narrow near a longitudinal center of the bearing 400 as compared to the relatively more longitudinally outward portions of the first neck portion 410. The angled body 408 also comprises a second neck portion 412 that is more narrow near the longitudinal center of the bearing 400 as compared to the relatively more longitudinally outward portions of the second neck portion 412. The bearing 400 further comprises a first angled stack 414 of elastomeric elements and rigid shims that complement the first neck portion 410 and a second angled stack 416 that complement the second neck portion 412. As compared to the bearings 308, 310, 312, 314, the bearing 400 comprises higher axial stiffness that can prevent coupling between misalignment and lateral motions.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A gimbal (200), comprising:
an intermediate plate (202);
a first plate (204) offset from the intermediate plate (202) in a first direction;
a first bearing (208) including a first rotational axis (209) connected between the intermediate plate (202) and the first plate (204);
a second plate (206) offset from the intermediate plate (202) in a second direction opposite the first direction; and
a third bearing (212) including a third rotational axis (213) connected between the intermediate plate (202) and the second plate (206).

2. The gimbal (200) of claim 1, wherein the first rotational axis (209) is substantially orthogonal to the third rotational axis (213).

3. The gimbal (200) of claim 1, wherein the first rotational axis (209) intersects the third rotational axis (213).

4. The gimbal (200) of claim 1, wherein each of the intermediate plate (202), the first plate (204), and the second plate (206) comprise a notch having a concavity open toward a radial direction (217).

5. The gimbal (200) of claim 4, wherein at least one of the first rotational axis (209) and the third rotational axis (213) is angularly offset by 45 degrees relative to the radial direction (217).

6. The gimbal (200) of claim 5, wherein the first rotational axis (209) is substantially orthogonal to the third rotational axis (213).

7. The gimbal (200) of claim 1, wherein the gimbal (200) is configured to withstand at least a 200 mT downward load.

8. The gimbal (200) of claim 1, wherein the gimbal (200) is configured to support at least one of a modular boosting unit (108) and a caisson (112).

9. The gimbal (200) of claim 1, configured for installation vertically above a moonpool (110) of a ship (102).

10. The gimbal (200) of claim 1, wherein the gimbal (200) is configured to allow an axial misalignment of at least about 20 degrees.

11. The gimbal (200) of claim 1, further comprising:
a second bearing (210) including a second rotational axis (211) connected between the intermediate plate (202) and the first plate (204).

12. The gimbal (200) of claim 11, wherein the first rotational axis (209) is substantially coaxial with the second rotational axis (211).

13. The gimbal (200) of claim 1, further comprising:
a fourth bearing (214) including a fourth rotational axis (215) connected between the intermediate plate (202) and the second plate (206).

14. The gimbal (200) of claim 13, wherein the fourth rotational axis (215) is substantially coaxial with the third rotational axis (213).

15. The gimbal (200) of claim 14, further comprising:
a second bearing (210) including a second rotational axis (211) connected between the intermediate plate (202) and the first plate (204).

16. The gimbal (200) of claim 15, wherein the first rotational axis (209) is substantially coaxial with the second rotational axis (211).

17. The gimbal (200) of claim 16, wherein in at least one orientation, each of the first rotational axis (209), the second rotational axis (211), the third rotational axis (213), and the fourth rotational axis (215) are coplanar.
